(19) United States
(12) Patent Application Publication
(10) Pub. No.: US 2024/0150163 A1
(43) Pub. Date: May 9, 2024

(54) BOTTLE FILLING AND CORKING DEVICE

(71) Applicant: Ivan Jordan, Exeter (GB)

(72) Inventor: Ivan Jordan, Exeter (GB)

(21) Appl. No.: 18/053,971

(22) Filed: Nov. 9, 2022

(51) Int. Cl. B67B 1/04; B67C 3/10

(52) U.S. Cl. CPC B67B 1/045; B67C 3/10

(57) ABSTRACT

A device for purging, filling and sealing a container comprising a collar having opposing ends and a body therebetween, the collar having a through hole, at one end of the collar in line with the through hole, there being an aperture shaped for receiving an opening of the container and forming an air tight seal therewith, the body comprising at least one gas inlet and liquid inlet respectively, each inlet having at least one valve and being in fluid communication with the container when in position. It also comprising a clamp for compressing a stopper for sealing the container, the clamp located at the opposing end of the collar to the aperture, the compression region of the clamp being in line with the through hole.

The present invention relates to a device for filling and corking bottles. Specifically, the present invention relates to a single device that can both fill and insert a stopper into a bottle. More specifically the invention relates to a single device which can purge, fill and cork a bottle, such as a wine/sparkling wine bottle.

### BACKGROUND OF THE INVENTION

Bottled beverages, such as but not limited to, wine and sparkling wine are immensely popular in society. Each one of these bottles needs to be filled and corked safely, and preferably efficiently.

The method of inserting a stopper/corking a bottle is well established and the method hasn't changed much through the years beyond new technology being used to perform the steps. In basic terms corking a bottle requires the cork/stopper to be compressed such that is it narrower than the bottle neck, the cork is then inserted into the bottle neck and allowed to expand such that it seals the bottle.

When filling the bottle, especially when dealing with beer, cider, delicate/sparkling wines. To ensure a long shelf life and avoid any unwanted harmful oxidisation after filling, all oxygen needs to be purged from the bottle before filling. This is typically done via purging with an inert gas (in some cases applying a vacuum to the bottle prior to purging with an inert gas). The gas is typically carbon dioxide but any suitable inert gas can be used.

When filling a bottle with a carbonated liquid it is standard practice to use counter pressure filling. A counter pressure (isobaric) bottle filler works by maintaining constant carbon dioxide (CO2) gas pressure on the beer, wine or soft drink as the bottle is filled. Bottles and drinks are typically chilled to reduce foaming due to temperature differences. The bottle is first pressurized with CO2, the fill valve is opened, and the CO2 is then vented to allow the bottle to fill from the bottom.

It is standard in the art to purge/fill the bottle with one device and insert the cork/stopper at a separate location.

It is an object of the current invention to provide a dual filling and corking device which uses the cork/stopper to form a counter pressure filling system, and then transferring the stopper into the neck of the container/bottle to seal it at the operator's discretion. Purging, the filling process, and stoppering are combined in one continued operation, eliminating unwanted loss of pressure or liquid, preventing contaminants such as dust or gaseous pollutants entering during the process. This also removes the need to transfer the container to a separate machine for sealing, as is currently the standard practice in the field.

### SUMMARY OF THE INVENTION

According to a first aspect of the invention there is provided a device for purging, filling and sealing a container comprising: a collar having opposing ends and a body therebetween, the collar having a through hole, at one end of the collar in line with the through hole, there being an aperture shaped for receiving an opening of the container and forming an air tight seal therewith, the body comprising at least one gas inlet and liquid inlet respectively, each inlet having at least one valve and being in fluid communication with the container when in position; and, a clamp for compressing a stopper for sealing the container, the clamp located at the opposing end of the collar to the aperture, the compression region of the clamp being in line with the through hole.

An embodiment of the first aspect further comprising a controlled piston in line with the through hole, for urging the stopper into the clamp and/or collar, then container opening.

An embodiment of the first aspect wherein the gas inlet comprises two valves, one of which being a bleed valve whose bleed pressure is set by the user.

An embodiment of the first aspect wherein the aperture comprises an O-ring seal.

An embodiment of the first aspect wherein the clamp is an iris clamp.

According to a second aspect of the invention there is provided a method for purging, filling and sealing a container using the device of the first aspect comprising the steps of:
a. Taking a container and placing its opening into the aperture of the collar forming an air tight seal,
b. Purging the container of ambient gasses using an inert gas introduced via the gas inlet,
c. Introducing a stopper into the clamp, compressing the stopper and then urging it into the through hole of the collar forming an air tight seal,
d. Filling the container with a liquid via the liquid inlet, excess gas escaping the container through the gas inlet,
e. Urging the stopper into the opening of the container, the stopper forming an air tight seal therewith.

An embodiment of the second aspect wherein the liquid is a carbonated liquid and step c further comprises pressurising the container to equilibrium with the carbonated liquid to be added. In step d the excess gas may escape via a bleed valve associated with the gas inlet. Alternatively step c further comprises the step of purging the container of gasses by means of a vacuum pump.

An embodiment of the second aspect wherein the stopper is urged by a user-controlled piston.

### BRIEF DESCRIPTION OF THE DRAWINGS

The invention will be described in more detail, by way of example, with reference to the following drawings:

FIG. 1 depicts an embodiment of the present invention prior to a container for filling being introduced;

FIG. 2 depicts the first step, purging the container to be filled with an inert gas;

FIG. 3 depicts an additional/alternate purging process, using a vacuum pump to remove substantially all gasses from the container.

FIG. 4 depicts the second step, pressurising the container to equilibrium with the liquid it is to be filled with;

FIG. 5 depicts the third step, counter pressure filling of the container;

FIG. 6 depicts the fourth step, sealing the container;

FIG. 7 depicts the fifth step, removing the filled and sealed container.

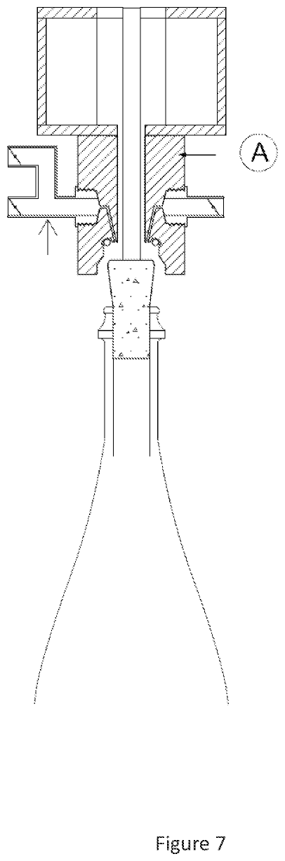

### DETAILED DESCRIPTION

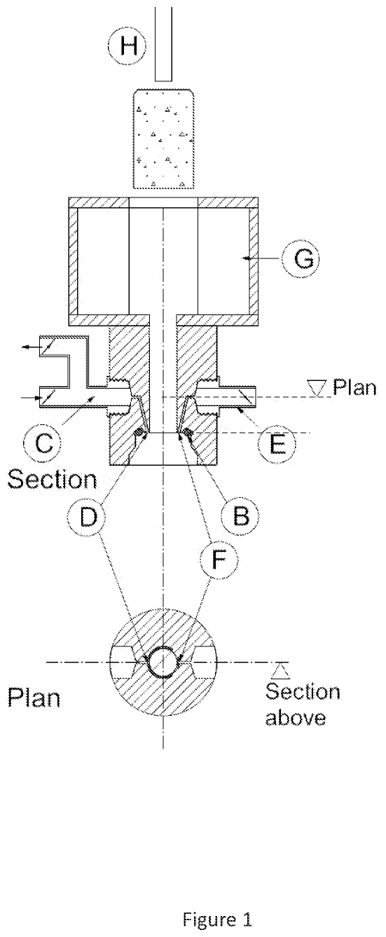

With reference to FIG. 1 the key for the references are as follows:
A. Block with a central aperture or void of a suitable size, orientation and alignment to form a contiguous chamber when connected to the container to be filled. Referred to as the “collar”.
B. O-ring retained in a channel, forming a gas-tight seal against the opening of the container.
C. Gas port, connected via valves to supplies and outlets, for two-way gas transfer.
D. Gas aperture adjacent the neck of the bottle, of sufficient area to reduce concentration, to avoid venturi effect when sending gas in or out.
E. Liquid port, connected via valves to supply of liquid to be bottled, pressurised or flat.
F. Liquid aperture of sufficient area to reduce concentration and turbulence in flow.
G. Clamp to compress stopper, prior to insertion. Connected to the collar. Preferably the clamp is an iris clamp for uniform compression, but any suitable clamp known to the skilled person can be used.
H. Piston to drive stopper into device and bottle, connected and aligned to the top mouth of collar.

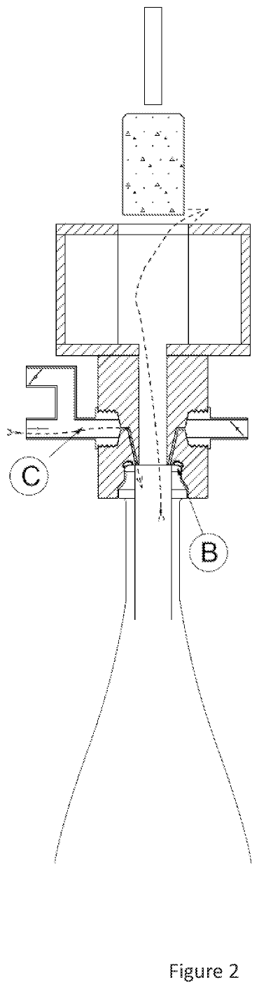

With reference to FIGS. 2-6 which depict the 5 steps of the method for using the present invention, a preferred embodiment relating to the filling and corking of a bottle of sparkling wine.

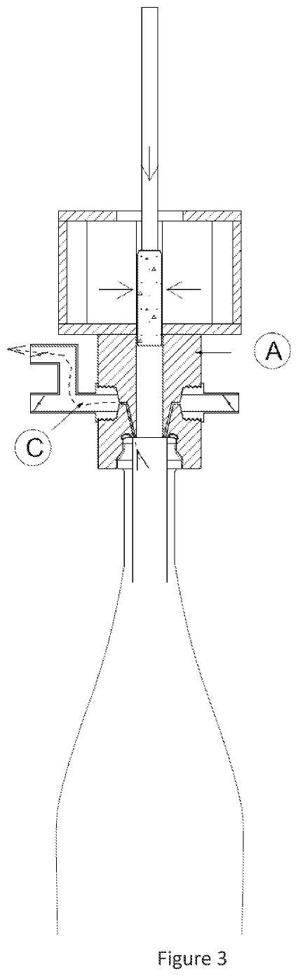

As shown in FIGS. 2 and 3, first the collar is pressed to the neck of the bottle so that a gas-tight seal is achieved at the contact point to the O-ring B, preferably able to withstand 6 or more bars of pressure. Then the purging process takes place. This can be done via a vacuum pump extracting substantially all gasses from the container as shown in FIG. 3 ensuring no gasses or oils remain that can spoil the beverage. Alternatively in the absence of a vacuum pump, the gas in valve is opened and CO2 or similar inert gas is let in to the bottle via the gas port C, directed downwards by the shape of the apertures as can be seen in the figures. Air and/or other ambient gases are driven upwards and out of the collar A and clamp G, due to displacement by the heavier CO2, which then fills the chamber from the bottom up with CO2/inert gas as shown in FIG. 2.

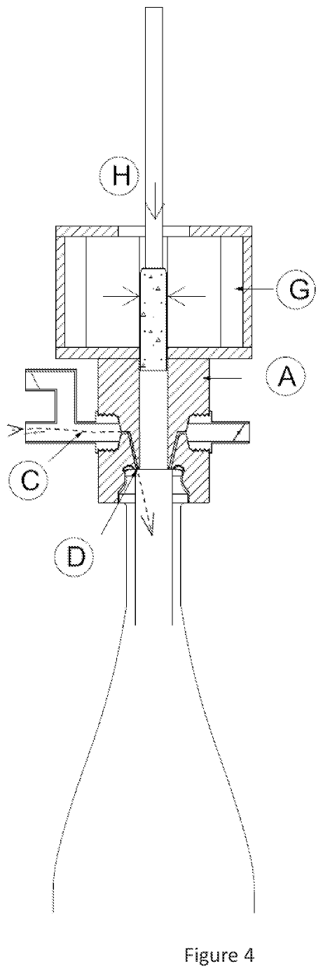

As shown in in FIG. 4, in the next step the cork/stopper is inserted into the iris clamp G via piston H, is compressed to a diameter equal or less than that of the collar's central void, and is then driven in to the top of the collar A by a piston H, to a depth sufficient to form a gas tight seal. The bottle, device and cork now form a sealed contiguous chamber.

CO2 or similar inert gas is then forced into the chamber via the gas port D, to a pressure in equilibrium or greater to the pressure of the sparkling (carbonated) wine (beverage), this is typically between 3 and 6 bars. The gas inlet valve is then shut.

Once the container is to pressure, as shown in FIG. 4, the liquid valve is opened. The gas outlet is also opened via a bleed valve which is separate to the gas inlet valve but both connected to gas port D, the bleed valve allows gas out when above a pressure set by the operator.

By allowing the pressurised CO2/inert gas to bleed out slowly, and not allow the pressure within the chamber to dip below a set level, the wine gradually enters and fills the bottle, without losing sufficient pressure to become “flat”. When sufficient liquid has entered the bottle, the gas bleed valve and liquid valve are then shut.

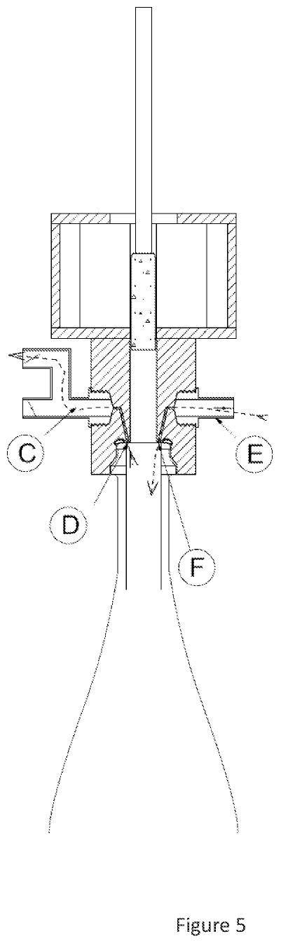

The next and fourth step as shown in FIG. 5, the cork is driven by the piston H through the collar A and into the neck of the bottle where it expands to form an substantially air tight seal.

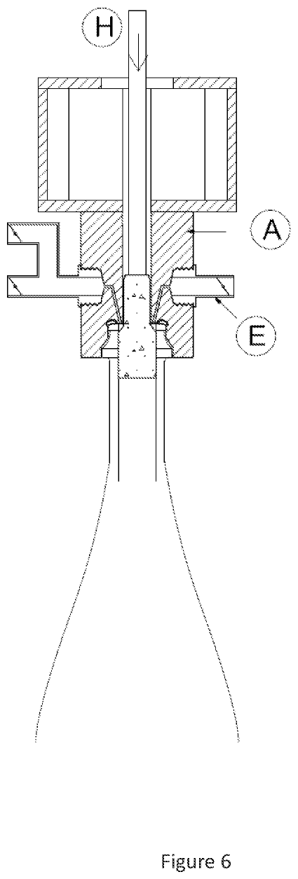

In the fifth and final step as shown in FIG. 6, the piston H remains holding the cork in place, as the collar A and attached clamp G are moved off and away from the bottle. The filled and corked bottle may now be removed, the piston H reset and the process can begin again.

The invention has been described with reference to a preferred embodiment. The description is intended to enable a skilled person to make the invention, not to limit the scope of the invention. The scope of the invention is determined by the claims.

1. A device for purging, filling and sealing a container comprising:
a collar having opposing ends and a body therebetween, the collar having a through hole, at one end of the collar in line with the through hole, there being an aperture shaped for receiving an opening of the container and forming an air tight seal therewith, the body comprising at least one gas inlet and liquid inlet respectively, each inlet having at least one valve and being in fluid communication with the container when in position;
and, a clamp for compressing a stopper for sealing the container, the clamp located at the opposing end of the collar to the aperture, the compression region of the clamp being in line with the through hole.

2. A device according to claim 1 further comprising a controlled piston in line with the through hole, for urging the stopper into the clamp and/or collar, then container opening.

3. The device according to claim 2 wherein the gas inlet comprises two valves, one of which being a bleed valve who's bleed pressure is set by the user.

4. The device according to claim 3 wherein the aperture comprises an O-ring seal.

5. The device according to claim 4 wherein the clamp is an iris clamp.

6. The device according to claim 2 wherein the aperture comprises an O-ring seal.

7. The device according to claim 2 wherein the clamp is an iris clamp.

8. The device according to claim 1 wherein the gas inlet comprises two valves, one of which being a bleed valve who's bleed pressure is set by the user.

9. The device according to claim 8 wherein the aperture comprises an O-ring seal.

10. The device according to claim 8 wherein the clamp is an iris clamp.

11. The device according to claim 1 wherein the aperture comprises an O-ring seal.

12. The device according to claim 1 wherein the clamp is an iris clamp.

13. A method for purging, filling and sealing a container using the device of any preceding claim comprising the steps of:
a. Taking a container and placing its opening into the aperture of the collar forming an air tight seal,
b. Purging the container of ambient gasses using an inert gas introduced via the gas inlet,
c. Introducing a stopper into the clamp, compressing the stopper and then urging it into the through hole of the collar forming an air tight seal,
d. Filling the container with a liquid via the liquid inlet, excess gas escaping the container through the gas inlet,
e. Urging the stopper into the opening of the container, the stopper forming an air tight seal therewith.

14. A method according to claim 13 wherein the liquid is a carbonated liquid and step c further comprises pressurising the container to equilibrium with the carbonated liquid to be added.

15. A method according to claim 13 wherein step c further comprises the step of purging the container of gasses by means of a vacuum pump.

16. A method according to claim 13 wherein in step d the excess gas escapes via a bleed valve associated with the gas inlet.

17. A method according to claim 14 wherein in step d the excess gas escapes via a bleed valve associated with the gas inlet.

18. A method according to claim 15 wherein in step d the excess gas escapes via a bleed valve associated with the gas inlet.

19. A method according to claim 13 to wherein the stopper is urged by a user-controlled piston.

20. A method according to claim 15 to wherein the stopper is urged by a user-controlled piston.
